(19) United States
(12) Patent Application Publication
(10) Pub. No.: US 2011/0065866 A1
(43) Pub. Date: Mar. 17, 2011

(54) Composition containing a halogenated vinyl polymer and a copolymer bearing associative groups

(75) Inventors: Ludwik Leibler, Paris (FR); Francois Genes Tournilhac, Paris (FR); Nicolas Dufaure, Bernay (FR); Manuel Hidalgo, Brignais (FR)

(73) Assignees: ARKEMA FRANCE, COLOMBES (FR); CENTRE NATIONAL DE LA RECHERCHE SCIENTIFIQUE-CNRS, PARIS (FR)

(21) Appl. No.: 12/991,218

(22) PCT Filed: May 5, 2009
(86) PCT No.: PCT/FR09/50826

§ 371 Date: Nov. 5, 2010

(30) Foreign Application Priority Data
May 7, 2008 (FR) 08 53029

(51) Int. Cl. C08L 39/04; C09D 139/04; C09J 139/04

(52) U.S. Cl. 525/186

(57) ABSTRACT

The present invention relates to a composition comprising: (a) at least one halogenated vinyl polymer and (b) at least one copolymer containing (i) units derived from a first monomer (A) rendering said copolymer compatible with said halogenated vinyl polymer and (ii) units derived from a second monomer (B) bearing at least one given associative group. The present invention also relates to the use of such a copolymer bearing associative groups, for improving certain properties of a halogenated vinyl polymer. The invention finally relates to the uses of the aforementioned composition.

The present invention relates to novel chemical compositions based on a halogenated vinyl polymer and on a copolymer bearing given associative groups.

“Supramolecular” materials are materials formed from compounds combined by non-covalent bonds, such as hydrogen, ionic and/or hydrophobic bonds. They may in particular be polymers onto which are grafted associative groups, which are capable of uniting via cooperative hydrogen bonds. An advantage of these materials is that these physical bonds are reversible, especially under the influence of the temperature or via the action of a selective solvent. The ease of implementation and/or the properties of the polymers, for instance the mechanical, rheological, thermal, optical, chemical or physicochemical properties, may thus be improved by the grafting of these associative groups. These groups may also impart the properties of polymers of large mass to polymers of low mass, which are easier to prepare in a controlled manner.

Document WO 2006/016 041 thus discloses polymers grafted with associative groups that give them a higher elastic modulus and better resistance to solvents.

Moreover, document U.S. Pat. No. 2,980,652 discloses a product resulting from the reaction of a unit bearing imidazolidone associative groups onto a copolymer derived from the copolymerization of certain monomers bearing anhydride functions, such as maleic anhydride or itaconic anhydride or citraconic anhydride, with at least one unsaturated ethylenic monomer. It is indicated that this product has good adhesion to metals, glass and plastics. Example 9 more particularly discloses the product of reaction of UDETA with a copolymer of maleic anhydride and of methyl methacrylate. This product is formulated as a lake that may be sprayed onto steel panels (Examples 14 and 15).

In this context, the Applicants became interested in means for modifying halogenated vinyl polymers such as PVC in order to make them into supramolecular materials and thus to improve their properties. Various tests were consequently undertaken, for the purpose of grafting imidazolidone associative groups onto PVC by reacting this compound with N-aminoethyl-2-imidazolidone (UDETA).

However, it appeared to the Applicants that the nucleophilic attack of UDETA on PVC lead to degradation of the latter by dehydrochlorination, with concomitant formation of hydrochloric acid, which rendered impossible the direct grafting of UDETA in bulk (without solvent) onto PVC in PVC transformation machines such as calenders, extruders of presses.

To circumvent this problem, other routes were envisioned, which, however, all have major drawbacks.

This is thus the case for grafting via a solvent route, which, although enabling adjustment of the operating conditions (concentration of PVC and UDETA, choice of solvent, temperature) to promote the substitution of the PVC with UDETA at the expense of its degradation, requires the use of large amounts of solvent.

In addition, although it represents an interesting alternative, the copolymerization of vinyl chloride monomer with methacrylic monomers bearing associative groups of imidazolidine type comes up against the difficulty of obtaining copolymers of homogeneous composition, given the large difference in reactivity ratios of methacrylic and acrylic monomers in general, with vinyl chloride monomer (VCM) (see J. Bandrup et al., Polymer Handbook, 3rd edition, John Wiley).

Finally, the grafting of associative groups onto a PVC via functions other than the amine function of UDETA, for instance the mercaptan function, do not offer a satisfactory solution either, since the synthesis of molecules bearing both associative functions of imidazolidine type and grafting units other than amine, for instance, these mercaptan functions, adds steps to the process for obtaining grafted PVCs.

The Applicant has, to its credit, developed a chemical composition that can lead to a material of PVC-based supramolecular type, which has improved properties while at the same time overcoming the above-mentioned drawbacks. To achieve this aim, the Applicant imagined an “indirect modification” of a halogenated vinyl polymer such as PVC, by mixing, during its implementation, with a monomer-rich copolymer which, after polymerization, give mixtures that are compatible with PVC and that moreover bear given associative groups. It is thus possible to obtain a highly compatible homogeneous mixture of polymers and indirectly to convey associative groups into the PVC for the purpose of giving it different properties.

More specifically, it has been demonstrated that the polymer bearing associative groups according to the invention can impart strong adhesion properties to metals and improved creep resistance to the halogenated vinyl polymer such as PVC and can optionally also give it improved rheological, mechanical or thermal properties, in particular greater elongation at break, better heat stability, a higher softening temperature and better strength of the melt at a low shear gradient.

Admittedly, it is already known from FR 2 891 548 that the adhesion of poly(vinylidene chloride) or PVDC to metal or polymer surfaces may be improved by mixing it with a copolymer containing monomers, especially acrylic monomers, bearing phosphonate groups and other monomers, especially acrylic monomers. However, it is not suggested in said document that the use of a copolymer bearing associative groups of nitrogenous heterocycle type can make it possible to improve several properties of halogenated vinyl polymers such as PVDF.

One subject of the present invention is thus a composition comprising: (a) at least one halogenated vinyl polymer and (b) at least one copolymer containing (i) units derived from a first monomer (A) that makes said copolymer compatible with said halogenated vinyl polymer and (ii) units derived from a second monomer (B) bearing at least one associative group chosen from imidazolidonyl, triazolyl, triazinyl, bis-ureyl and ureidopyrimidyl groups, preferably imidazolidonyl.

The halogenated polymer may in particular be a fluorinated and/or chlorinated homopolymer or copolymer. It is generally a thermoplastic polymer.

A preferred example of a chlorinated polymer is poly(vinyl chloride) or PVC. Such a polymer is especially sold by the company Arkema under the trade name Lacovyl®. Other chlorinated polymers that may be used in this invention are poly(chlorinated vinyl chloride) (PCVC) such as Lucalor® from Arkema and copolymers of vinyl chloride with monomers such as acrylonitrile, ethylene, propylene, vinyl acetate, and also poly(vinylidene chloride) or acrylic derivatives. It is also possible for the chlorinated polymer according to the invention to be a mixture including at least two of the above chlorinated polymers or copolymers. In the case of copolymers of vinyl chloride, it is preferable for the proportion of vinyl chloride units to be greater than 25% and preferably less than 99% of the total weight of the copolymer.

As fluorinated polymers, mention may be made especially of those comprising one or more monomers of formula (I):

CFX═CHX′ (I)

in which X and X′ independently denote a hydrogen or halogen atom (in particular fluorine or chlorine) or a perhalogenated (in particular perfluorinated) alkyl radical. It is in particular preferred that X═F and X′═H.

As examples of fluorinated polymers, mention may be made especially of:
poly(vinylidene fluoride) (PVDF),
copolymers of vinylidene fluoride with, for example, hexafluoropropylene (HFP), chlorotrifluoroethylene (CTFE), hexafluoropropylene (HFP), trifluoroethylene (VF3) or tetrafluoroethylene (TFE),
trifluoroethylene (VF3) homopolymers and copolymers,
fluoroethylene/propylene (FEP) copolymers,
copolymers of ethylene with fluoroethylene/propylene (FEP), tetrafluoroethylene (TFE), perfluoromethyl vinyl ether (PFMVE), chlorotrifluoroethylene (CTFE) or hexafluoropropylene (HFP), and
mixtures thereof,
   some of these polymers being sold especially by the company Arkema under the trade name Kynar®.

PVDF and PVC are preferred for use in the present invention.

The halogenated vinyl polymer may be obtained according to processes of polymerization in suspension, in microsuspension, in emulsion or in bulk, which are well known to those skilled in the art.

It may represent from 1% to 99.5% by weight and preferably from 50% to 99% by weight relative to the total weight of the composition according to the invention.

This halogenated vinyl polymer may be formulated in a composition that leads, after use, to a final material that is either rigid or plasticized. The plasticization is obtained by incorporating into the composition including the halogenated vinyl polymer at least one plasticizer that may be chosen, for example, from: polymeric plasticizers such as polyphthalates and polyadipates; monomeric plasticizers such as azelates, trimellitates (TOTM, TEHTM, etc.), sebacates (DIOS, DINS, DIDS, etc.), adipates (DOA, DEHA, DINA, DIPA, etc.), phthalates (DOP, DEHP, DIDP, DINP, etc.), citrates, benzoates, tallates, glutarates, fumarates, maleates, oleates, palmitates, acetates such as, in particular, acetylated monoglycerides; and mixtures thereof. Phthalates such as dioctyl phthalate, dialkyl adipates such as bis(tridecyl) adipate (BTDA), diacetyl monoglycerides such as glyceryl monolaurate diacetate and dialkyl sebacates such as diisodecyl sebacate (DIDS) are preferred for use in the present invention. The amount of plasticizer may represent, for example, from 60% to 100% by weight relative to the weight of the halogenated vinyl polymer.

Besides the optional plasticizer, this halogenated vinyl polymer is combined, in the composition according to the invention, with a copolymer bearing associative groups, to form a “compound”.

This copolymer contains units of at least a first monomer (A) that makes said copolymer compatible with said halogenated vinyl polymer and contains at least a second unit (B), which is different than unit (A) and which bears a given associative group. Monomer (A) preferably represents at least 20 mol % and advantageously not more than 80 mol % of the copolymer.

The term “compatible” means that the halogenated vinyl polymer and the copolymer (b) form a homogeneous mixture, in the sense that they have miscibility such that at least the amorphous phase (non-crystalline) of the halogenated vinyl polymer is swollen by the copolymer or that this amorphous phase of the halogenated vinyl polymer swells the copolymer, in the proportions used in the mixture. This is reflected by the fact that at least the amorphous phase of the halogenated vinyl polymer and the copolymer form only one phase. Depending on the nature of the copolymer and in particular of monomer (A) used for its synthesis, the compatibility within the meaning of the invention with the halogenated vinyl polymer may be obtained in variable proportions of the mixture of the two polymers. This compatibility may be demonstrated by physical miscibility measurements.

This miscibility may be detected by various analytical methods known to those skilled in the art, such as scanning electron microscopy (SEM) or transmission electron microscopy (TEM), or alternatively atomic force microscopy (AFM), which often make it possible to detect inhomogeneities in the mixtures in the form of characteristic size ranges of greater than 1 micron (immiscibility), and also by measurements of glass transition temperature, Tg, of the mixture of the two polymers: the miscibility is then reflected by the existence of only one Tg for the mixture. The methods for measuring the Tg of polymers and polymer mixtures are known to those skilled in the art and include differential scanning calorimetry (DSC), volumetrics or dynamic mechanical analysis (DMA). It is also possible to determine the miscibility via optical measurements such as transparency. When the miscibility is determined by transparency measurements in non-crystalline or sparingly crystalline polymeric systems, such as PVC, the difference in transparency between that of a specimen or piece of the mixture, from 2 to 4 mm thick, and the transparency of a specimen or piece of the halogenated vinyl polymer alone and of the same thickness, should not be perceptible to the naked eye; in other words, when the mixture is not compatible within the meaning of the invention, a haze or opacity that is sufficiently perceptible to the eye and readily quantifiable by optical transparency measurements known to those skilled in the art (such as the percentage of transmittance or the percentage of turbidity) appear in comparison with a sample of the halogenated vinyl polymer alone. When the halogenated vinyl polymer is considerably crystalline, as in the case of PVDF, the comparison of transparencies between the halogenated vinyl polymer alone and its mixture with the copolymer may also be performed on very thin films, typically with thicknesses of about 25 microns.

Thus, any copolymer bearing associative and compatible groups, within the meaning explained above, with the halogenated vinyl polymer may be used according to the invention, in particular any copolymer based on a monomer (A) whose corresponding homopolymer is known to be miscible with the halogenated vinyl polymer or in which the presence of units derived from the monomer (A) makes it compatible with the halogenated vinyl polymer. As non-exclusive examples of monomers (A), mention may be made of (meth)acrylic monomers such as methyl methacrylate, polyethylene glycol methacrylate, methoxypolyethylene glycol methacrylate and acrylonitrile; and also maleic anhydride. As examples of copolymers bearing associative groups that may be mixed, in variable proportions according to their nature and that of the halogenated vinyl polymer, with the halogenated vinyl polymer to obtain the compatibility and the “indirect modification” effects via reversible physical bonds according to the invention, mention may be made of methyl methacrylate copolymers (referred to as copolymers of PMMA type) bearing associative groups, copolymers of monomers with a polyethylene glycol side chain (referred to as copolymers with a PEG side chain) bearing associative groups, maleic anhydride copolymers bearing associative groups or acrylonitrile copolymers bearing associative groups.

The term “associative groups” means groups that are capable of associating with each other via hydrogen bonds, advantageously via 1 to 6 hydrogen bonds. The associative groups that may be used according to the invention are more specifically chosen from imidazolidonyl, triazolyl, triazinyl, bis-ureyl and ureidopyrimidyl groups, imidazolidonyl groups being preferred.

According to one preferred embodiment of the invention, the associative groups may be introduced during the formation of the copolymer. The copolymer may thus be obtained by copolymerization of monomer (A) with a monomer (B) that bears the associative groups and optionally one or more other monomers, preferably starting with:
on the one hand, a monomer (A) that is a (meth)acrylic monomer chosen from: methyl methacrylate, (methoxy) polyethylene glycol (meth)acrylate, acrylonitrile and maleic anhydride,
on the other hand, a monomer (B) bearing associative groups as defined previously, preferably imidazolidonyl groups, which is advantageously chosen from: ethylimidazolidone methacrylate (or EIOM) and ethyl-imidazolidonemethacrylamide (or WAM II) and
optionally, one or more other monomers chosen from acrylic or methacrylic acids, esters thereof, amides thereof or salts thereof, itaconic acid, esters thereof, amides thereof or salts thereof, and styrene and derivatives thereof, for instance 4-styrene sulfonate.

Such a copolymer may be prepared according to known methods of radical polymerization in solution in solvents such as chloroform or tetrahydrofuran or in dispersed medium, such as, in particular, in suspension or in aqueous emulsion. Preferably, the copolymer used in the invention may be obtained by radical polymerization in suspension or in aqueous emulsion. In the case of polymerizations in solution or in aqueous suspension, the polymerization may be initiated using radical polymerization initiators that are soluble in the monomer mixture. Various mechanisms for generating radicals may be used, for instance thermal decomposition, redox reactions, decomposition mediated by electromagnetic radiation, and in particular ultraviolet radiation. Non-exclusive examples of initiators include hydroperoxides, dialkyl peroxides, diacyl peroxides, peroxyesters, peroxydicarbonates, peroxyacetals, azo compounds and a combination thereof with agents that promote their decomposition, for instance amines and metal atoms.

Examples of hydroperoxides that may be mentioned include tert-butyl hydroperoxide, tert-amyl hydroperoxide, cumyl hydroperoxide, 2,5-dimethyl-2,5-bis(hydroperoxy)hexane, diisopropylbenzene monohydroperoxide and para-menthane hydroperoxide.

Examples of dialkyl peroxides that may be mentioned include 2,5-dimethyl-2,5-bis(tert-butylperoxy)hexyne-(3), di-tert-butyl peroxide, di-tert-amyl peroxide, 1,3-bis(tert-butylperoxyisopropyl)benzene, 2,5-dimethyl-2,5-bis(tert-butylperoxy)hexyne, 1,1,4,4,7,7-hexamethylcyclo-4,7-diperoxynonane and 3,3,6,6,9,9-hexamethylcyclo-1,2,4,5-tetraoxanonane.

Examples of diacyl peroxides that may be mentioned include benzoyl peroxide, lauroyl peroxide, decanoyl peroxide, 3,5,5-trimethylhexanoyl peroxide, and acetyl cyclohexylsulfonyl peroxide.

Examples of peroxyesters that may be mentioned include tert-butyl peroxybenzoate, tert-butyl peroxyacetate, tert-butyl peroxy-3,5,5-trimethylhexanoate, tert-amyl peroxy-3,5,5-trimethylhexanoate, 2,5-dimethyl-2,5-bis(benzoylperoxy)hexane, 00-tert-butyl-0-isopropyl-monoperoxycarbonate, 00-tert-butyl-0-(2-ethylhexyl)-monoperoxycarbonate, tert-butyl peroxyisobutyrate, tert-butyl peroxy-2-ethylhexanoate, tert-amyl peroxy-2-ethylhexanoate, 2,5-dimethyl-2,5-bis(2-ethylhexanoyl-peroxy)hexane, tert-butyl peroxyneodecanoate, tert-butyl peroxyisononanoate, tert-butyl peroxypivalate, tert-amyl peroxypivalate, α-cumyl peroxyneodecanoate, tert-amyl peroxydecanoate, tert-butyl 3-hydroxy-1,1-dimethylbutylperoxyneodecanoate and tert-butyl peroxymaleate.

Examples of peroxydicarbonates that may be mentioned include bis(2-ethylhexyl)peroxydicarbonate, dicyclohexyl peroxydicarbonate, bis(n-propyl)peroxydicarbonate and bis(4-tert-butylcyclohexyl)peroxydicarbonate.

Examples of peroxyacetals that may be mentioned include 1,1-bis(tert-butylperoxy)cyclohexane, 1,1-bis(tert-butylperoxy)-3,3,5-trimethylcyclohexane, ethyl 3,3-bis-(tert-butylperoxy)butyrate, ethyl 3,3-bis(tert-amyl-peroxy)butyrate, ethyl 3,3-bis(tert-amylperoxy)-butyrate, n-butyl 4,4-bis(tert-butylperoxy)valerate, 2,2-bis(tert-butylperoxy)butane, 1,1-bis(tert-amyl-peroxy)cyclohexane and 2,2-bis[4,4-bis(tert-butyl-peroxy)cyclohexyl]propane.

Examples of azo compounds that may be mentioned include 2,2′-azobis(isobutyronitrile) or 2-[(E)-(1-cyano-1-methylethyl)diazenyl]-2-methylpropanenitrile, 2-[(E)-(1-cyano-1-methylpropyl)diazenyl]-2-methylbutanenitrile or azobis(methylbutyronitrile), azobis(isobutyramide), dimethyl azobis(diisobutyrate), diethyl azobis-(isobutyrate), cyanovaleric acid or 4-[(E)-(3-carboxy-1-cyano-1-methylpropyl)diazenyl]-4-cyanopentanoic acid.

The polymerization may also be initiated by initiators-controllers of controlled radical polymerization, such as alkoxyamines and more particularly with 2-methyl-2-[N-tert-butyl-N-(diethoxyphosphoryl-2,2-dimethyl-propyl)aminoxy]propionic acid having the following formula:

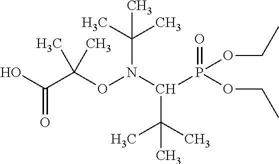

sold by Arkema under the brand name BlocBuilder® and the metallic or organic salts thereof.

These initiators may be used in a proportion of from 0.05% to 10% by weight relative to the total weight of the monomers.

In the case of polymerizations in organic solution, in suspension or in aqueous emulsion, in addition to the polymerization initiators, it may prove useful to dissolve other additives in the monomers, among which mention may be made of chain-transfer agents, for reducing the molecular masses. Examples of chain-transfer agents that may be mentioned include alkyl mercaptans, for instance methyl mercaptan, ethyl mercaptan, n-propyl mercaptan, isopropyl mercaptan, n-butyl mercaptan, tert-butyl mercaptan, cyclohexyl mercaptan, benzyl mercaptan, n-octyl mercaptan, tert-nonyl mercaptan, n-dodecyl mercaptan, tert-dodecyl mercaptan, alkyl thioglycolates, for instance methyl thioglycolate, ethyl thioglycolate, 2-ethylhexyl thioglycolate or isooctyl thioglycolate. The chain-transfer agents are generally used in proportions of between 0.01% and 10% and preferably between 0.5% and 2% by weight relative to the total weight of the monomers.

In the case of polymerizations in organic solution or in dispersed medium, such as polymerization in suspension or in aqueous emulsion, it is also possible to dissolve other additives in the monomers, such as antioxidants, for instance butylhydroxytoluene (BHT), biocides and/or polymerization initiator activators. These additives are generally used in proportions of between 0.01% and 5% by weight relative to the total weight of the monomers.

In the case of polymerizations in aqueous suspension, the monomer mixture comprising the polymerization initiator, and optionally other additives dissolved in this mixture, is dispersed in continuous aqueous phase containing a suspension agent that promotes the stability of the suspension during the polymerization. Among the suspension agents that may be used, non-exclusive examples that may be mentioned include finely divided mineral powders, for instance talc or calcium triphosphate, polymer suspension agents, also occasionally known as protective colloids, for instance partially or totally hydrolyzed polyvinyl alcohols, copolymers of styrene and of methyl methacrylate with or without a third monomer such as α-methylstyrene, certain surfactants such as ethoxylated sorbitan esters, thickening water-soluble polymers, for instance hydroxyethylcellulose, polymers and copolymers based on (meth)acrylic acid or salts thereof, polymers and copolymers based on (meth)acrylamide and derivatives thereof or polyacrylamido (methyl)propane sulfonate. The suspension agents are generally used in proportions ranging from 0.05% to 10% and preferably from 0.1% to 5% by weight relative to the total weight of the dispersed phase containing the monomers.

In combination with the suspension agents, it is possible to envisage other additives added to the aqueous phase, such as salts, for instance sodium or ammonium sulfates, which are occasionally known as “extenders”, for controlling the ionic strength of the medium, or pH regulators, for instance sodium bicarbonate. They may be used in proportions ranging from 0.05% to 5% by weight relative to the total weight of the continuous aqueous phase.

In the case of polymerizations in aqueous emulsion, water-soluble radical polymerization initiators are used. Various mechanisms for generating radicals may be used, for example thermal decomposition, redox reactions, decomposition mediated by electromagnetic radiation, and in particular ultraviolet radiation. Non-exclusive examples of water-soluble initiators include hydroperoxides, for instance tert-butyl hydroperoxide, water-soluble azo compounds such as 2,2′-azobis(2-amidinopropane)dihydrochloride and the organic or mineral salts of 4,4′-azobis(4-cyanovaleric acid), mineral oxidizing agents such as sodium, potassium or ammonium persulfate, hydrogen peroxide, perchlorates, percarbonates and ferric salts. These oxidizing agents may be used alone or in combination with mineral or organic reducing agents such as sodium or potassium bisulfite or metabisulfite, vitamin C (ascorbic acid), and sodium or potassium hypophosphite. These organic or mineral reducing agents may also be used alone, i.e. in the absence of mineral oxidizing agents. The initiators that are soluble in the aqueous phase are used in the case of emulsion polymerizations, in proportions ranging from 0.01% to 10% by weight relative to the total weight of the monomers.

In the case of polymerizations in aqueous emulsion, surfactants or stabilizers for constituting the starting emulsions and for stabilizing the final latices obtained may be used. Three families of surfactants or stabilizers may be considered, mainly:
1) surfactant molecules of natural or synthetic origin having a dispersant and stabilizing effect by electrostatic repulsion and comprising positively or negatively charged amphiphilic molecules, or forming zwitterions (amphoteric), in aqueous phase, among which non-exclusive examples that may be mentioned include: sodium or potassium alkyl sulfates or sulfonates, in particular sodium dodecyl sulfate, sodium or potassium alkyl aryl sulfates or sulfonates, in particular sodium dodecylbenzene sulfonate, the potassium, sodium or ammonium salts of fatty acids, in particular sodium stearate, alkylated and disulfonated diphenyl ethers, in particular the commercial surfactants of the range Dowfax®, for instance Dowfax® 2A1, sulfosuccinates and in particular the commercial surfactants of the Aerosol® range such as Aerosol® MA 80 which is sodium dihexyl sulfosuccinate or Aerosol® OT-75 which is sodium dioctyl sulfosuccinate, phosphoric esters, fatty amines, polyamines and salts thereof, quaternary ammonium salts, for instance alkyltrimethyl-ammonium chlorides or bromides, betaines such as N-alkyl betaines or sulfobetaines, imidazoline carboxylates, and ethoxylated derivatives of all these compounds;
2) surfactant molecules with a dispersant and stabilizing effect by steric repulsion, which are uncharged or nonionic, among which non-exclusive examples that may be mentioned include: ethoxylated alkylphenols, ethoxylated fatty alcohols, copolymers containing polyethylene oxide blocks and polypropylene oxide blocks, such as those of the Pluronic® range, fatty acid esters, alkyl polyglycosides;
3) amphiphilic or totally hydrophilic, charged or uncharged polymeric molecules, among which non-exclusive examples that may be mentioned include: water-soluble polymers of natural or synthetic origin such as (meth)acrylic acid polymers and copolymers and salts thereof, acrylamide polymers and copolymers and derivatives thereof, polymers based on vinyl alcohol and vinyl acetate, hydroxyethylcellulose and hydrophobic-modified hydroxyethylcellulose, polyvinylcaprolactam and polyvinylpyrrolidone.

These dispersants or stabilizers used in emulsion polymerization are generally present in a proportion of from 0.1% to 10% by weight relative to the total weight of the monomers. It is also possible to perform emulsion polymerizations in the absence of surfactants or stabilizers or dispersants; in this particular case, the final proportions of the polymer, expressed as final solids content or final dry extract, i.e. after evaporation of the volatiles and in particular of the water, are less than 20% by weight relative to the total weight of the latex derived from the emulsion polymerization.

The solution processes, on the one hand, and suspension or aqueous emulsion processes, on the other hand, that may be used for the synthesis of the copolymers bearing associative groups, used according to the invention, may be performed at atmospheric pressure or under pressure and at polymerization temperatures of between 5° C. and 180° C. Preferably, the copolymer is obtained via a suspension or aqueous emulsion process at atmospheric pressure and at polymerization temperatures of between 50 and 95° C. The final concentrations or concentrations after polymerization of polymer and of other nonvolatile components for the solution, aqueous suspension or aqueous emulsion polymerizations are between 1% and 75% and preferably between 15% and 50% by weight, expressed as dry extract or final solids content, relative to the total weight of the solution, suspension or emulsion (latex).

The process for synthesizing the copolymer may be continuous or batchwise, or alternatively of semi-continuous type, i.e. with metered additions of components, for instance metered additions of monomers, in native form or pre-emulsified, metered additions of additives, for instance dispersants or stabilizers, initiators or other additives.

In general, the preferred aqueous suspension and aqueous emulsion processes used to obtain the copolymer bearing the associative groups according to the invention are well known to those skilled in the art and are described in general and specialized publications, for instance in chapter 7 of the book Les latex synthétiques: Elaboration, Propriétés, Applications, coordinated by C. Pichot and J. C. Daniel (TEC&DOC Editions from Lavoisier, France, 2006).

In another embodiment of the invention, the copolymer may be obtained by grafting associative groups onto an already-constituted copolymer comprising, besides the monomer (A), a monomer (B′) containing at least one reactive function, such as an acid, anhydride, alcohol, mercaptan, amine, epoxy or isocyanate function, preferably an anhydride, by reaction of one or more modifiers, bearing, on the one hand, an associative group, and, on the other hand, a reactive group, chosen from amine, mercaptan, epoxy, isocyanate, anhydride and alcohol groups, preferably amine, said reactive group being capable of forming a covalent bond with said reactive function.

In this embodiment, the copolymer bearing reactive functions may, for example, be an alkyl (meth)acrylate homopolymer or copolymer, for example having a number-average molecular mass ranging from 1000 to 1 000 000 g/mol and preferably from 5000 to 100 000 g/mol, advantageously containing glutaric anhydride functions. This may be obtained from a copolymer of an alkyl, especially methyl, (meth)acrylate and of (meth)acrylic acid, for instance the Altuglas® HT 121 grade from Arkema, for example containing between 1 mol % and 15 mol % of (meth)acrylic acid units, according to a cyclization process, under basic catalysis conditions, which may especially be performed in an extruder. Among the preferred basic catalysts are sodium hydroxide and sodium methoxide NaOCH₃. The cyclization may be performed by passage through a single-screw or twin-screw extruder of the starting copolymer with the catalyst and optionally other additives, such as lubricants, antioxidants, dyes and/or optical correctors to give gloss and to reduce the yellowing. The extrusion temperature may be between 200 and 300° C. and preferably between 250 and 280° C. One or more extrusion passages may be performed to obtain the desired level of cyclization (formation of glutaric anhydride). The degree of cyclization may be controlled so as to adjust the content of anhydride functions obtained, which may range, for example, from 0.1 mol % to 20 mol %.

It is thus understood that, in this embodiment, the copolymer comprising the monomer (B′) may be obtained by cyclization of a copolymer of an alkyl (meth)acrylate and of (meth)acrylic acid, under basic catalysis conditions.

The reactive and associative groups, respectively, of the modifier may be separated by a rigid or flexible chain, formed from 1 to 30 carbon atoms, at least some of which may be substituted, and optionally from one or more heteroatoms, chosen in particular from sulfur, oxygen and nitrogen, said chain optionally containing one or more ester or amide bridges. It is preferably a linear or branched C₁-C₁₀ alkylene chain optionally interrupted with one or more nitrogen atoms, more preferentially a linear C₁-C₆ alkylene chain.

Preferred examples of modifiers are amines bearing an imidazolidonyl group such as 1-(2-aminoethyl)imidazolidin-2-one (UDETA), 1-(2-[(2-aminoethyl)amino]ethyl)imidazolidone (UTETA), 1-(2-{2-[(2-aminoethylamino]ethyl}amino)ethyl]imidazolidone (UTEPA), 3-amino-1-H-1,2,4-triazole (3-ATA) and 4-amino-1-H-1,2,4-triazole (4-ATA). UDETA is preferred for use in the present invention.

The amines bearing imidazolidone functions may themselves be derived from the reaction of urea with at least one compound chosen from alkyleneamines and amines. Thus, UDETA may be prepared by reacting urea with diethylenetriamine (DETA).

The number of associative groups borne by the copolymer in this embodiment according to the invention may be simply adjusted by varying the amount of modifier or the reaction time and temperature. It is generally preferred for the amount of modifier to represent from 0.5% to 15% by weight and more preferentially from 1% to 5% by weight relative to the weight of the copolymer bearing reactive functions and/or for the mean number of associative groups per copolymer chain to be between 1 and 30.

The grafting process is performed by reacting the modifier and the copolymer bearing reactive functions. This step may be performed in the melt, for example in an extruder or an internal mixer at a temperature that may range from 150° C. to 300° C. and preferably from 200 to 280° C. The modifier is mixed with the polymer alone, or with the aid of an additive for impregnating the grains of solid polymer with the premelted modifier. The solid mixture before introduction into the extruder or the mixer may be made more homogeneous by refrigeration to solidify the modifier. It is also possible to meter out this modifier in the extruder or the mixer after the start of melting of the polymer to be grafted. The time at the grafting temperature may range from a few seconds to 5 minutes. The modifier may be introduced into the extruder in the form of a masterbatch in a polymer, which may preferably be the polymer to be grafted. According to this mode of introduction, the masterbatch may comprise up to 30% by weight of modifier; next, the masterbatch is “diluted” in the polymer to be grafted during the grafting operation. According to another possibility, the grafting may be performed by reaction in solvent phase, for example in anhydrous chloroform. In this case, the reaction temperature may range from 5° C. to 75° C., for a time ranging from a few minutes to one day and at concentrations of polymer before grafting of between 1% and 50% by weight relative to the total weight of the solution.

The copolymer bearing associative groups obtained according to one or other of the above embodiments may especially be in the form of granules or powder. It is mixed with the halogenated vinyl polymer described previously by any means, especially by calendering, extrusion, melt-blending in a mixing chamber, pressing, injection, dissolution in a common solvent followed by separation of the solvent.

The copolymer bearing associative groups represents, for example, from 0.1% to 50% by weight of this mixture, for example from 0.5% to 10% by weight in the case of PVC and from 5% to 40% by weight in the case of PVDF.

It has been demonstrated that this copolymer can improve certain mechanical, chemical and/or thermal properties of the halogenated vinyl polymer with which it is mixed.

A subject of the present invention is thus also the use of a copolymer bearing associative groups as described previously, for modifying one or more of the following properties of a rigid or plasticized halogenated vinyl polymer: its creep resistance, in particular above 25° C., its glass transition temperature (Tg), its Vicat softening point, its adhesion to metallic surfaces such as steel or aluminum surfaces, its elongation at break, in particular above 25° C., its melt strength or melt elongation viscosity, its chemical resistance and its thermal stability.

Besides the copolymer bearing associative groups according to the invention, the halogenated vinyl polymer and the plasticizers of the above-mentioned plasticized formulations, the composition according to the invention may also contain various additives, including:
lubricants, such as stearic acid and esters thereof (including Loxiol® G12 from Cognis), waxy esters (including Loxiol® G70 S from Cognis), polyethylene waxes, paraffin or acrylic lubricants (including the Plastistrength® products, especially L1000, from Arkema),
mineral or organic pigments, such as carbon black or titanium dioxide,
heat and/or UV stabilizers, such as tin, lead, zinc, cadmium, barium or sodium stearates, including Thermolite® from Arkema,
costabilizers such as epoxidized natural oils, in particular epoxidized soybean oils such as Ecepox® PB3 from Arkema,
antioxidants, for example phenolic, sulfur-containing or phosphite antioxidants,
fillers or reinforcers, especially cellulose-based fillers, talc, calcium carbonate, mica or wollastonite, glass or metal oxides or hydrates,
antistatic agents,
fungicides and biocides,
impact strength agents, such as MBS copolymers, including Clearstrength® C303H from Arkema, and acrylic modifiers of core-shell type such as Durastrength® from Arkema,
swelling agents such as azodicarbonamides, azobis(isobutyronitrile) and diethyl azobis(iso-butyrate),
flame retardants, including antimony trioxide, zinc borate and brominated or chlorinated phosphate esters,
solvents, and
mixtures thereof.

These additives may, for example, represent from 0.1% to 50% of the total weight of the composition.

In addition to the solid form, this composition may especially be in the form of emulsions, suspensions or solutions.

The composition according to the invention may be used for the manufacture of coatings, especially floor and wall coatings, furniture, grille components or trim parts of motor vehicles (such as dashboard, steering wheel and door trims); clothing; seals, especially in the building or motor vehicle industry; self-adhesive, food-grade, agricultural or stationery films; roof sheets and plates, and also siding plates; profiles, especially for showers and windows; shutters, doors, plinths, cornices; cables; and fluid transportation or storage devices, in particular tubes, sheaths, pumps, valves or adaptors; switch boxes; watering tubes; bottles and flasks, sheets, especially for wrapping; stretchable films; blood or solution bags; transfusion tubes; microgroove disks; toys; panels; helmets; shoes; drapes, curtains or tablecloths; buoys; gloves; blinds; fibers; glues and adhesives; membranes.

A subject of the invention is thus also the abovementioned uses.

This composition may be formed by calendaring, extrusion, extrusion-blow molding, injection-molding, rotary molding, thermoforming, etc.

The invention will be understood more clearly in the light of the examples that follow, which are given for purely illustrative purposes, and with reference to the attached figures, in which:

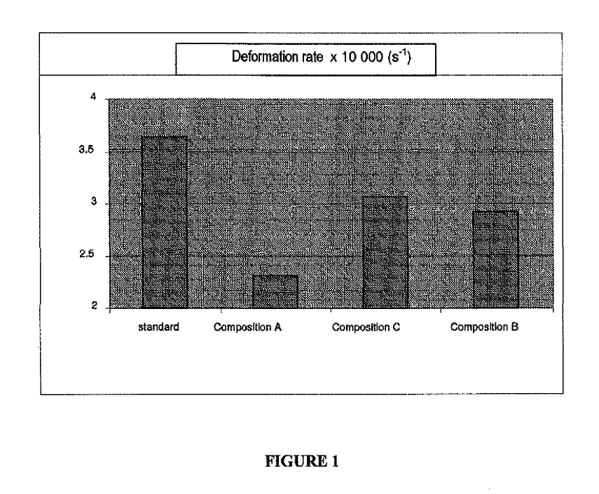

FIG. 1 illustrates the deformation speed in a creep test at 60° C. under a stress of 18 MPa, of the control or “standard” composition and of compositions A, B and C according to the invention,

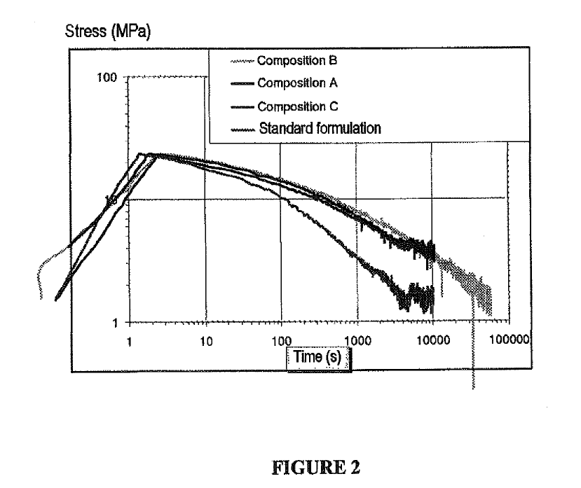

FIG. 2 illustrates the relaxation and stress properties at 60° C. of compositions based on rigid PVC and copolymers according to the invention,

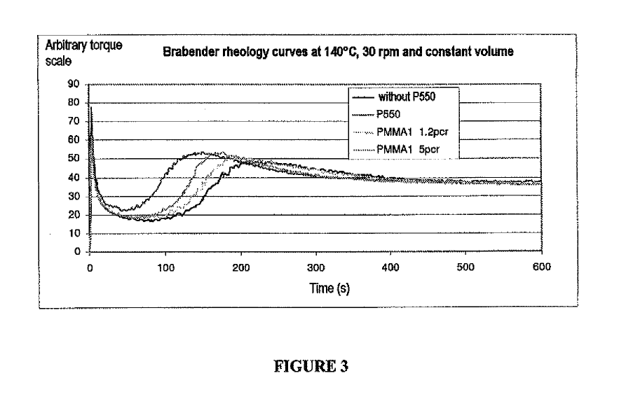

FIG. 3 illustrates the implementation-facilitating properties (acceleration of gelation of the rigid PVC) provided by the copolymers according to the invention,

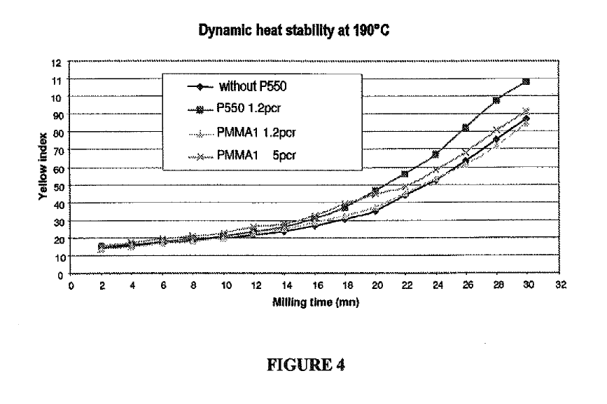

FIG. 4 illustrates the dynamic heat stability behavior of compositions modified with copolymers according to the invention,

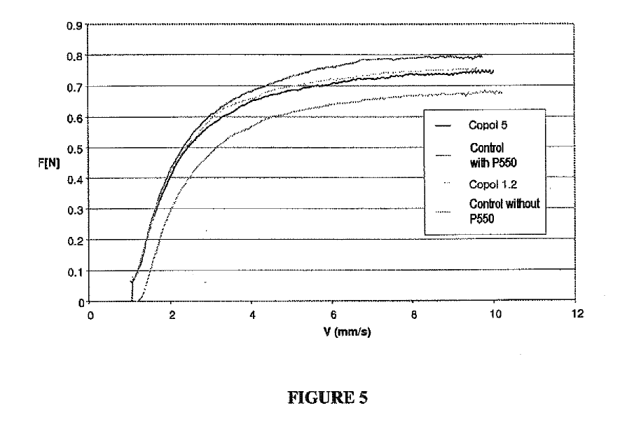

FIG. 5 illustrates the improvement in melt strength of molten compositions containing the copolymers according to the invention.

### EXAMPLES

### Example 1

### Preparation of a Copolymer According to the Invention by Grafting of Associative Groups

A modifier, namely UDETA bearing an imidazolidonyl associative group and an amine reactive group, was grafted onto a copolymer of methyl methacrylate, methacrylic acid and glutaric anhydride. This copolymer is itself obtained by partial cyclization of a copolymer of methyl methacrylate and methacrylic acid. The cyclization reaction may be performed in the melt in an extruder or any other suitable mixer, optionally with the aid of a basic catalyst such as sodium hydroxide. This reaction may also be performed in an oven under high vacuum. The grafting reaction on the copolymer bearing the glutaric anhydride functions may then be performed, either in the melt in an extruder or any other suitable mixer, or in solution in a suitable solvent such as chloroform.

Specifically, a copolymer of methyl methacrylate and methacrylic acid sold by Arkema under the name Altuglas® HT121 (copolymer containing about 4% by weight of methacrylic acid comonomer) was partially cyclized by extruding it twice through a co-rotating twin-screw extruder of Leistritz type with a screw diameter of 34 mm and a length/diameter ratio of 32, at an extrusion temperature of 280° C., and using 0.09% by weight of a strong base such as sodium hydroxide or sodium methoxide, NaOCH₃. After two passages, the acid groups of the initial copolymer had a tendency to cyclize to more than 90% by reaction with either a neighboring acid group (loss of water) or with a neighboring methyl ester group (loss of methanol).

The copolymer thus obtained was then grafted with UDETA by extrusion of the cyclized copolymer as a mixture with the UDETA in the same type of extruder. The screw profile was configured such that it consecutively comprises a melting zone (for melting the polymer), an injection zone (for injecting the UDETA) and a depressurization/degassing zone (for removing the volatiles). The nominal temperature profile of the sheaths was set at 30/200/220/220/220/220/220/220/220° C., the flow rate was set at 20 kg/h and the screw spin speed was set at 150 rpm. The copolymer was introduced into a hopper via a gravimetric feeder. The UDETA was injected after the melting zone by means of a metering micropump via an injector for regulating the injection pressure, the flow rate being monitored by loss of weight on a balance. On the degassing zone, an absolute dynamic vacuum of 700 mm Hg was applied to ensure removal of the volatile compounds. The UDETA, with a purity of greater than 80% by weight, was introduced at a rate of 2% by mass, relative to the total copolymer-UDETA. At the extruder outlet, the product was cooled and formed into granules.

### Example 2

### Preparation by Copolymerization of a Copolymer Bearing Associative Groups

3800 g of demineralized water and 200 g of an aqueous solution of Alcotex® 72.5 polyvinyl alcohol from Harco (72.5% of vinyl alcohol units and 27.5% of vinyl acetate units) as suspending agent, were introduced into a 10-liter metallic reactor equipped with a variable-speed stirring motor, inlets for introducing reagents, lines for introducing inert gases to be able to strip out the oxygen, such as nitrogen, and measuring probes (for example for measuring the temperature), a vapor condensation system with reflux, and a jacket for heating/cooling the contents of the reactor by circulating a heat-exchange fluid therein. The stirring was started at moderate speed, heating of the system was started so as to reach at least 70° C. in the reactor, and the liquid was degassed by bubbling nitrogen through for at least 15 minutes.

A mixture comprising:
1500 g of methyl methacrylate from Arkema;
100 g of ethyl acrylate from Arkema;
400 g of Norsocryl® N102 from Arkema, a mixture of 25% by weight of ethyl imidazolidone methacrylate (EIOM) and 75% of methyl methacrylate;
7.6 g of n-dodecyl mercaptan from Arkema; and
6 g of Luperox® 26R from Arkema, as peroxide initiator;
   were separately prepared, in a suitable container.

When the temperature of the water in the reactor reached at least 70° C., the stirring speed therein was brought to 350 revolutions per minute (rpm) and the mixture of monomers and additives was loaded into the reactor so as form a liquid aqueous suspension. The nominal temperature for the heat-exchange fluid of the reactor jacket was then set so that the reactor temperature was above 70° C. during the polymerization. The reactor was thus maintained at a polymerization temperature of at least 70° C. for a minimum time of 4 hours. A “baking” treatment intended to minimize the residual monomer was then performed by raising the reactor temperature to at least 80° C. for at least a further 1 hour, and the suspension was then cooled to room temperature.

The product obtained was in the form of macroscopic particles (grains or beads) in aqueous suspension. The suspension was removed from the reactor and centrifuged or filtered so as to separate the hydrophobic polymer (grains) thus obtained from the aqueous continuous phase. The grains freed of the excess of aqueous phase were then dried in an oven or a dryer, with or without application of vacuum and preferably without exceeding 55° C. during the drying so as to avoid their aggregation. The dried grains were crushed and screened so as to obtain a final product in the form of a homogeneous white powder. The powder thus obtained will be referred to hereinbelow as “PMMA1 powder”.

Another copolymer powder was manufactured in a similar manner, using as monomer mixture: 1100 g of methyl methacrylate, 100 g of ethyl acrylate and 800 g of Norsocryl® N102. The powder thus obtained will be referred to hereinbelow as “PMMA2 powder”.

Syntheses of copolymers bearing associative groups according to the invention were also performed by controlled radical polymerization in suspension according to the method illustrated hereinbelow:

317.2 g of demineralized water and 0.73 g of Alcotex® 72.5 polyvinyl alcohol from Harco as suspension agent were introduced into a 1-liter glass reactor equipped with a variable-speed stirring motor, inlets for introducing reagents, lines for introducing inert gases so as to strip out the oxygen, for instance nitrogen, and measuring probes (for example for measuring the temperature), a vapor condensation system with reflux, and a jacket for heating/cooling the reactor contents by circulating a heat-exchange fluid therein. The stirring was started at moderate speed, heating of the system was started so as to reach at least 50° C. in the reactor, and the liquid was degassed by bubbling nitrogen through for at least 20 minutes.

The following were separately prepared, in suitable containers:
1) a mixture comprising:
   87 g of methyl methacrylate; and
   59.8 g of Norsocryl® N104 from Arkema, a mixture of 50% by weight of ethyl imidazolidone methacrylate (MOM) and 50% of methyl methacrylate;
2) 35.2 g of an aqueous solution (demineralized water) containing 7% by weight of BlocBuilder® alkoxyamine from Arkema, neutralized with a few drops of an aqueous potassium hydroxide solution at 36% by weight, to make the BlocBuilder® water-soluble, which takes place at a pH of 12.

When the temperature of the water in the reactor reached 50° C., the stirring speed in the reactor was brought to 500 revolutions per minute (rpm) and the monomer mixture (1) and the solution of the BlocBuilder® alkoxyamine (2) were then added in parallel into the reactor, by means of metering pumps, over a period of 60 minutes. During this time, the temperature of the reactor was maintained at least 50° C. At the end of the addition, the temperature was maintained at least 50° C. for at least a further 2 hours. A “baking” treatment for minimizing the residual monomer was then applied by raising the temperature of the reactor to at least 60° C. for at least a further 1 hour, after the end of the addition of the monomers. After this “baking”, the suspension was cooled to room temperature.

The product obtained was in the form of macroscopic particles (grains or beads) in aqueous suspension. The suspension was removed from the reactor and filtered so as to separate the hydrophobic polymer (grains) thus obtained from the aqueous continuous phase. The grains freed of the excess of aqueous phase were then dried in an oven, with or without application of vacuum and taking care never to exceed 55° C. during the drying so as to avoid their aggregation. The dried grains were crushed and screened so as to obtain a final product in the form of a homogeneous white powder. The powder thus obtained will be referred to hereinbelow as “PMMA3 powder”.

Another copolymer powder was manufactured in a manner similar to that described for the “PMMA3” powder, in a 2-liter glass reactor equipped as previously, and starting with 1327.6 g of demineralized water and 2.94 g of Alcotex® 72.5, using as monomer mixture 540 g of methyl methacrylate and 47 g of Norsocryl® N104, and also 82.1 g of an aqueous solution (demineralized water) containing 12% by weight of BlocBuilder® alkoxyamine from Arkema, neutralized with a few drops of an aqueous potassium hydroxide solution at 36% by weight, to make the BlocBuilder® water-soluble, which takes place at a pH of 12. The degassing with nitrogen was performed as for the synthesis of “PMMA3” and the stirring speed used was 600 revolutions per minute. The monomers, and similarly the alkoxyamine solution, were run in in parallel over 90 minutes. The polymerization temperature was at least 50° C.; two hours after the end of the addition, baking was performed for at least 1.5 hours at least 70° C. The powder thus obtained will be referred to hereinbelow as “PMMA4 powder”.

| | Theoretical | Number of associative | Tg |
|---|---|---|---|
| Powder | molar mass | groups/chain | (° C.) |
| PMMA1 | 40 000 | 10 | 98 |
| PMMA2 | 40 000 | 20 | 94 |
| PMMA3 | 25 000 | 25 | 101 |
| PMMA4 | 25 000 | 5 | 101 |

### Example 3

### Preparation of Compositions According to the Invention Based on Rigid PVC

The granules obtained in Example 1 and the PMMA1 powder obtained in Example 2 were each mixed in a proportion of 5% by weight with the same pulverulent preparation (referred to hereinbelow as the “standard composition”) based on rigid PVC, for 5 minutes, using a two-roll Collin calender heated to 190° C.; the rotation speed of the two rolls was adjusted, respectively, to 20 and 24 revolutions per minute. Sheets 0.5 mm thick were thus obtained.

The standard composition contained the following constituents indicated in Table 1 below;

TABLE 1

| | | Parts by |
|---|---|---|
| Constituent | Commercial name | weight |
| PVC | Lacovyl ® SO71 from | 100 |
| | Arkema (KW 57) | |
| Stabilizer (octyltin | Thermolite ® T892WF | 1.5 |
| thioester) | from Arkema | |
| Epoxidized soybean oil | Ecepox ® PB3 from | 1 |
| | Arkema | |
| Polyethylene oxide wax | AC316A ® from | 0.12 |
| | Honeywell | |
| Lubricant based on glyceryl | Loxiol ® G12 from | 1.0 |
| monostearate | Cognis | |
| Lubricant based on waxy | Loxiol ® G70S from | 0.5 |
| ester | Cognis | |
| Formulating agent based on | Plastistrength ® 550 | 1.2 |
| acrylic polymer | from Arkema | |
| Formulating agent based on | Plastistrength ® 770 ® | 1.0 |
| styrene-acrylic polymer | from Arkema | |
| Impact modifier based on MBS | Clearstrength ® | 8 |
| copolymer | C303H from Arkema | |

The compositions prepared from the copolymer granules of Example 1 and from the PMMA1 copolymer powder of Example 2 were designated, respectively, Composition A and Composition B.

A composition C was moreover prepared, which corresponded to Composition A to which was added 0.3 per (parts per hundred parts of resin) of a lubricant (Plastistrength® L1000 from Arkema) to facilitate the formation of a film.

### Example 4

### Mechanical and Optical Tests

### Example 4A

### Creep at 60° C.

Compositions A, B and C were subjected to a creep test at 60° C., in comparison with the standard PVC composition described in Example 3.

### 4A-1. Protocol

The test consists in imposing a constant tensile force on a test material and in measuring the change of the resulting deformation over time. For a given force, the greater the creep resistance of the material, the lower the deformation over time. This force is expressed as a stress, by relating the force to the initial cross section of the specimen, so as to overcome the effect of the geometry of the specimen used. This specimen is typically a tensile testing specimen of ISO 527 1BA type cut out using a punch. The test is performed on an MTS810 tensile testing machine. The load cells used can measure a maximum stress of 2500 N. The samples are left for one hour at 60° C. before the test. A stress of 18 MPa is applied and the resulting deformation of the sample is measured over time.

### 4A-2. Results

As illustrated in FIG. 1, Compositions A, B and C, containing the copolymer according to the invention, have better creep resistance than the standard PVC composition used as control.

This test thus demonstrates that the copolymers according to the invention improve the creep resistance of rigid PVC at 60° C., irrespective of their mode of preparation.

### Example 4B

### Stress Relaxation at 60° C.

Compositions A, B and C were subjected to a stress relaxation test at 60° C., by comparison with the standard PVC composition described in Example 3.

### 4B-1. Protocol

The test consists in imposing a constant tensile deformation on the test material and in measuring the change in the resulting force over time. For a given deformation, the greater the resistance of the material, the lower the relaxation of the force over time. This force is expressed as a stress, by relating the force to the initial cross section of the specimen, so as to overcome the effect of the geometry of the specimen used. This specimen is typically a tensile testing specimen of ISO 527 1BA type cut out with a punch. The test is performed on an MTS810 tensile testing machine. The load cells used can measure a maximum stress of 2500 N. The samples are left for one hour at 60° C. before the test. A deformation of 2% is applied and the force exerted on the sample is measured over time.

### 4B-2. Results

As illustrated in FIG. 2, Compositions A, B and C, containing the copolymer according to the invention, have better resistance than the standard PVC composition used as control. The difference is large taking into account the logarithmic scale.

This test thus demonstrates that the copolymers according to the invention improve the mechanical strength of rigid PVC at 60° C., irrespective of their mode of preparation.

### Example 4C

### Color and Transparency

Optical tests (color and transparency) were performed on Composition B compared with the standard composition.

### 4C-1. Protocol

The protocols followed for performing these L* a* b* color measurements according to the Hunter scale, yellow index, YI, and also transparency, clarity and haze measurements are known to those skilled in the art and are described in standards ASTM E313 and D1003.

### 4C-2. Results

The optical properties measured on Composition B are summarized in Table 2 below:

TABLE 2

| | Standard | Composition |
|---|---|---|
| | composition | B |
| Thickness (mm) | 0.5 | 0.5 |
| L* (black→white) | 92 | 92.9 |
| D65/10° | | |
| a* (green→red) | −0.15 | −0.2 |
| D65/10° | | |
| b* (blue→yellow) | 6.7 | 7.0 |
| D65/10° | | |
| Yi (ASTM E313) | 12.8 | 13.2 |
| Transmittance | 91.6 standard | 92.7 standard |
| (%) | deviation | deviation |
| | (0.2) | (0.3) |
| Haze (%) | 3.4 standard | 1.5 standard |
| | deviation | deviation |
| | (0.5) | (0.2) |
| Clarity (%) | 98.1 standard | 98 standard |
| | deviation | deviation |
| | (0.5) | (0.5) |

These measurements show the very good incorporation of the PMMA1 copolymer of Example 2 into a PVC-based formulation, which is reflected by virtually unchanged coloration and transparency properties.

### Example 4D

### Other Tests

A new standard composition, similar to that detailed in Table 1, was prepared with, instead of the 0.5 part by weight of the lubricant Loxiol® G70S, the same weight proportion of the lubricant Barolub® 43C. Starting with this formulation, three compositions were prepared, namely:

1) the “control composition” including, as detailed in Table 1, 1.2 parts by weight of formulation aid Plastistrength® P550,
2) the composition “Copol 1.2” in which the P550 is replaced with 1.2 parts by weight of the PMMA1 polymer of Example 2,
3) the composition “Copol 5” in which the P550 is replaced with 5 parts by weight of the PMMA1 polymer of Example 2. Comparative tests of “gelation” of rigid PVC, of dynamic heat stability, of melt strength and of optical properties were then performed.

### 4D-1. Gelation of PVC. Protocol and Results

The tests were performed in a Brabender mixing chamber of constant volume, at a temperature of 140° C. and with a spindle spin speed of 30 revolutions per minute. The torque of the mixture was then recorded as a function of the mixing time. FIG. 3 shows the results of the recording. After the first rapid rise in torque associated with passage from the powder to the molten state, a second maximum may be detected, corresponding to “gelation” of the composition. The shorter the time for appearance of this second peak and the sharper (less broad) the peak, the greater the acceleration effect of the gelation caused by the additive (in this case P550 or PMMA1 copolymer).

These measurements show that the PMMA1 copolymer has a formulation aid effect on rigid PVC, all the more so since it is known to those skilled in the art that PMMA that is not modified with associative groups does not give rise to this gelation acceleration effect.

4D-2. Optical Properties. Protocol and Results

The optical properties of sheets prepared according to the protocol described in Example 3, but with a temperature of 175° C. for 5 minutes, were measured according to the protocols described in Example 4C-1. Table 3 below shows the results of the transparency and color (YI) measurements.

TABLE 3

| | Control | Control | | |
|---|---|---|---|---|
| | composition | composition | Copol 1.2 | Copol 5 |
| | without P550 | with P550 | composition | composition |
| Thickness | 0.5 | 0.5 | 0.5 | 0.5 |
| (mm) | | | | |
| Transmit- | 92 | 91 | 93 | 93 |
| tance (%) | | | | |
| Haze (%) | 2.3 | 2.9 | 2 | 2 |
| Clarity (%) | 98 | 99 | 98 | 98 |
| YI (ASTM | 12 | 13 | 12 | 13 |
| E313) | | | | |

These measurements show the very good incorporation of the PMMA1 copolymer of Example 2 into a PVC-based formulation, which is reflected by virtually unchanged coloration and transparency properties.

4D-3. Dynamic Heat Stability. Protocol and Results

The implementation process using the Collin calender of Example 3 is used with a roll temperature of 200° C. At regular intervals, samples are removed from the calender to measure their optical properties, as described above, and in particular the yellow index or Y.I. FIG. 4 shows the results obtained; the lower the yellow index, the better the heat stability of the composition.

These measurements show the very good behavior of the copolymers bearing the associative groups according to the invention, since the yellow index remains close to that of the control without formulation aid, whereas the conventional formulation aids such as Plastistrength 550 degrade the dynamic heat stability, and all the more so when the calendering time increases.

4D-4. Melt Strength. Protocol and Results

The control compositions with and without the formulation aid P550 and Copol 1.2 and Copol 5 described previously were extruded and passed through a machine of Rheotens-Göttfert type. The extrusion conditions of the test are summarized in Table 4 below:

TABLE 4

| | Control | Control | Copol 1.2 | Copol 5 |
|---|---|---|---|---|
| | composition | composition | composition | composition |
| | without | with P550 | with | with |
| | P550 | (1.2 parts) | PMMA1 | PMMA1 |
| Screw | 25 | 25 | 25 | 25 |
| speed | | | | |
| (rpm) | | | | |
| T zone 1 | 130 | 130 | 130 | 130 |
| (° C.) | | | | |
| T zone 2 | 170 | 170 | 170 | 170 |
| (° C.) | | | | |
| T zone 3 | 170 | 170 | 170 | 170 |
| (° C.) | | | | |
| T die | 180 | 180 | 180 | 180 |
| (° C.) | | | | |
| T bulk | 150 | 150 | 150 | 150 |
| (° C.) | | | | |
| T bulk at | 180 | 184 | 185 | 180 |
| the top | | | | |
| (° C.) | | | | |
| Pressure | 550 | 575 | 560 | 550 |
| 18D (bar) | | | | |
| Pressure | 610 | 620 | 605 | 600 |
| 22D (bar) | | | | |
| Pressure | 340 | 350 | 340 | 340 |
| 25D (bar) | | | | |
| Pressure | 230 | 240 | 230 | 230 |
| at the top | | | | |
| (bar) | | | | |
| Torque | 100 | 103 | 100 | 100 |
| (N m) | | | | |
| Flow rate | 1.3 | 1.4 | 1.4 | 1.4 |
| (kg/hr) | | | | |

The elongation results of the test are presented in Table 5 below. These results correspond to passage through the rolls and show that the elongation is comparable for all the compositions. On the other hand, the melt strength is improved with a standard formulation aid and similarly with the copolymers bearing associative groups according to the invention. These results are illustrated graphically in FIG. 5.

TABLE 5

| | Control | Control | Copol 1.2 | Copol 5 |
|---|---|---|---|---|
| | composition | composition | composition | composition |
| | without | with P550 | with | with |
| | P550 | (1.2 parts) | PMMA1 | PMMA1 |
| Acceleration | 24 | 24 | 24 | 24 |
| (mm/s²) | | | | |
| V0 (mm/s) | 93 | 96 | 93 | 88 |
| Vmax | | | | |
| (break) | 831 | 884 | 850 | 878 |
| (mm/s) | | | | |
| Fmax (N) | 0.67 | 0.79 | 0.75 | 0.75 |
| (V/V0) max | 10.2 | 9.8 | 9.7 | 10.0 |
| (elongation) | | | | |
| Stressₘₐₓ | 2.19 | 2.46 | 2.31 | 2.38 |
| (MPa) | | | | |
| Flow rate | 1.4 | 1.4 | 1.4 | 1.3 |
| (kg/hr) | | | | |
| T bulk (° C.) | 180 | 180 | 180 | 180 |

The tests of Example 4 together show that the copolymers bearing associative groups according to the invention are capable of improving the properties of the compositions giving rise to rigid and transparent PVC, such as gelation of the PVC, the dynamic heat stability and the melt strength, without degrading the optical properties. These properties are also improved by standard formulation aids, but these aids degrade the dynamic heat stability of the compositions significantly more than the copolymers according to the invention.

### Example 5

### Preparation of Compositions According to the Invention Based on Plasticized PVC

Four compositions each containing 5 parts by weight of a copolymer powder of Example 2, respectively PMMA1, PMMA2, PMMA3 and PMMA4 were prepared in a mixture of 100 parts by weight of Lacovyl® (KW70) PVC from Arkema, 5 parts by weight of epoxidized soybean oil, 50 parts by weight of dioctyl phthalate (DOP) and 4 parts by weight of a stabilizer based on liquid Ca/Zn.

These compositions will be referred to hereinbelow, respectively, as Compositions 1, 2, 3 and 4.

### Example 6

### Mechanical Tests

Compositions 1 to 4 prepared in Example 5 were subjected to tensile tests and also to a measurement of their Shore hardness according to methods that are well known to those skilled in the art and relative to a control not containing the copolymers of the invention. Their static heat stability at 200° C. was moreover evaluated by determining the maximum time before the samples have a burnt appearance. These tests are performed comparatively relative to a control not containing the copolymers of the invention, for which the static heat stability is 21 minutes.

The results of these tests are collated in Table 6 below.

TABLE 6

| | Shore | Stability | Young' s | Breaking | Elongation |
|---|---|---|---|---|---|
| | hardness | at 200° C. | modulus | strength | at break |
| Composition | (A) | (min) | (MPa) | (MPa) | (%) |
| Control | 75 | 21 | 9 | 18 | 340 |
| 1 | 78 | 26 | 9.5 | 17.5 | 360 |
| 2 | 79 | 27 | 9 | 18 | 360 |
| 3 | 79 | 32 | 9 | 18 | 350 |
| 4 | 79 | 38 | 9 | 18.5 | 365 |

It emerges from these tests that compositions 1 to 4 containing the copolymer bearing associative groups according to the invention have a greater elongation at break and above all improved stability at high temperature without substantially affecting the other mechanical properties.

### Example 7

### Creep Tests at Room Temperature

Specimens of compositions 1 and 2 of Example 5 were subjected to a creep test as described in Example 4A, but at room temperature. A sample of the control composition without copolymer was also subjected to the test. The applied stress was 6.25 MPa and the test lasted 15 minutes. The deformation rate values obtained were as follows:
Control: 54.2 mm/hr
Composition 1: 44.4 mm/hr
Composition 2: 51.1 mm/hr

These results show the favorable effect of the copolymers of the invention for reducing the creep of plasticized PVC compositions.

1. A composition comprising: (a) at least one halogenated vinyl polymer and (b) at least one copolymer containing (i) units derived from a first monomer (A) that makes said copolymer compatible with said halogenated vinyl polymer and (ii) units derived from a second monomer (B) bearing at least one associative group chosen from imidazolidonyl, triazolyl, triazinyl, bis-ureyl and ureidopyrimidyl groups, preferably imidazolidonyl.

2. The composition as claimed in claim 1, wherein the halogenated vinyl polymer is chosen from: poly(vinyl chloride) (PVC); poly(chlorinated vinyl chloride) (PCVC); copolymers of vinyl chloride with monomers chosen from acrylonitrile, ethylene, propylene and vinyl acetate; poly(vinylidene chloride); and mixtures thereof.

3. The composition as claimed in claim 2, wherein the halogenated vinyl polymer is poly(vinyl chloride).

4. The composition as claimed in claim 1, wherein the halogenated vinyl polymer is chosen from:
poly(vinylidene fluoride) (PVDF),
copolymers of vinylidene fluoride with, for example, hexafluoropropylene (HFP), chlorotrifluoroethylene (CTFE), hexafluoropropylene (HFP), trifluoroethylene (VF3) or tetrafluoroethylene (TFE),
trifluoroethylene (VF3) homopolymers and copolymers,
fluoroethylene/propylene (FEP) copolymers,
copolymers of ethylene with fluoroethylene/propylene (FEP), tetrafluoroethylene (TFE), perfluoromethyl vinyl ether (PFMVE), chlorotrifluoroethylene (CTFE) or hexafluoropropylene (HFP), and
mixtures thereof,
preferably PVDF.

5. The composition as claimed in claim 1, wherein the halogenated vinyl polymer represents from 1% to 99.5% by weight and preferably from 50% to 99% by weight relative to the total weight of the composition.

6. The composition as claimed in claim 1, wherein the monomer (A) represents at least 20 mol % of the copolymer.

7. The composition as claimed in claim 1, wherein said monomer (A) is a (meth)acrylic monomer such as methyl methacrylate, (methoxy)polyethylene glycol (meth)acrylate, acrylonitrile or maleic anhydride.

8. The composition as claimed in claim 1, wherein the copolymer may be obtained by grafting associative groups onto an already-existing copolymer comprising, besides the monomer (A), a monomer (B′) containing at least one reactive function, such as an acid, anhydride, alcohol, mercaptan, amine, epoxy or isocyanate function, preferably an anhydride function, by reaction of one or more modifiers, bearing, on the one hand, an associative group, and, on the other hand, a reactive group, chosen from amine, mercaptan, epoxy, isocyanate, anhydride and alcohol groups, preferably amine groups, said reactive group being capable of forming a covalent bond with said reactive function.

9. The composition as claimed in claim 8, wherein the copolymer containing the monomer (B′) may be obtained by cyclization of a copolymer of an alkyl (meth)acrylate and of (meth)acrylic acid, under basic catalysis conditions.

10. The composition as claimed in claim 1, wherein the copolymer may be obtained from:
on the one hand, a monomer (A) that is a (meth)acrylic monomer chosen from: methyl methacrylate, (methoxy)polyethylene glycol (meth)acrylate, acrylonitrile and maleic anhydride,
on the other hand, a monomer (B) bearing associative groups, preferably imidazolidinyl groups, which is advantageously chosen from: ethylimidazolidone methacrylate (or EIOM) and ethylimidazolidone methacrylamide (or WAM II) and
optionally, one or more other monomers chosen from acrylic or methacrylic acids, esters thereof, amides thereof or salts thereof, itaconic acid, esters thereof, amides thereof or salts thereof, and styrene and derivatives thereof, for instance 4-styrene sulfonate.

11. A method for modifying one or more of the following properties of a rigid or plasticized halogenated vinyl polymer: its creep resistance, in particular above 25° C., its glass transition temperature (Tg), its Vicat softening point, its adhesion to metallic surfaces such as steel or aluminum surfaces, its elongation at break, in particular above 25° C., its melt strength or melt elongation viscosity, its chemical resistance and its thermal stability, comprising mixing the halogenated vinyl polymer with a copolymer bearing associative groups as described in claim 1.

12. An item selected from the group consisting of coatings; clothing; seals; roof sheets and plates; shutters, doors, plinths, cornices; cables; fluid transportation or storage devices; switch boxes; watering tubes; bottles; flasks; sheets; stretchable films; blood or solution bags; transfusion tubes; microgroove disks; toys; panels; helmets; shoes; drapes, curtains; tablecloths; buoys; gloves; blinds; fibers; glues; adhesives and membranes, made from a composition as claimed in claim 1.
